(19) United States
(12) Patent Application Publication
(10) Pub. No.: US 2002/0009099 A1
(43) Pub. Date: Jan. 24, 2002

(54) Broadband access to multiple dwelling units for voice and data communications

(75) Inventor: Vincent M. D'Onofrio, Harrison, NY (US)

Correspondence Address: Charles N. J. Ruggiero, Esq., Ohlandt, Greeley, Ruggiero & Perle, L.L.P., 10th Floor, One Landmark Square, Stamford, CT, 06901-2682, US

(73) Assignee: ONTERA, INC.

(21) Appl. No.: 09/896,081

(22) Filed: Jun. 29, 2001

Related U.S. Application Data
(60) Provisional application No. 60/215,525, filed on Jun. 30, 2000.

(51) Int. Cl. H04J 3/22

(52) U.S. Cl. 370/467; 370/480

(57) ABSTRACT

There is provided a communication network. The communication network comprises (a) a multiplexer located in a building having a plurality of units, in which the multiplexer is coupled to the plurality of units via a local communication link, and (b) a switch coupled to the multiplexer via a synchronous optical network (SONET), for routing one or more communication packets between the multiplexer and a plurality of communication service providers. The plurality of units can transmit and receive the one or more communication packets to and from the plurality of communication service providers via the multiplexer.

### CROSS REFERENCE TO RELATED APPLICATIONS

The present application is claiming priority of U.S. Provisional Patent Application Ser. No. 60/215,525, which was filed on Jun. 30, 2000, the content of which is herein incorporated by reference.

### BACKGROUND OF THE INVENTION

1. Field of the Invention

The present invention relates to broadband communication, and more particularly, to a system that allows a tenant of a multiple dwelling unit to select one or more broadband services from any of a plurality of service providers.

2. Description of the Prior Art

A broadband communications network uses fixed network lines, typically copper wiring or cables, to provide services such as high-speed data, voice and video to a consumer over the last mile of the network. These services, in turn, allow for applications such as email, file transfer, video and music downloading and viewing, electronic shopping, direct advertising, Internet surfing, multi-person gaming and other applications.

Conventionally, a consumer wishing to obtain broadband service must do so through a local telephone company, i.e. a local exchange carrier (LEC). The LEC accesses a broadband trunk, and couples signals to and from the trunk to a digital subscriber loop access multiplexer (DSLAM), which is normally deployed in a service-wiring center of the LEC. The LEC thereafter distributes the broadband service to consumers.

Given such an arrangement, the consumer usually does not have any choice with regard to the selection of service providers. That is, the consumer can obtain broadband service only through the LEC that services the geographic area within which the consumer is located.

A CLEC desiring to provide residential service typically has only two ways to enter such a market, either through a UNE P arrangement with the ILEC or through a resale of the ILEC service. Both are poor choices for a service provider that is serious about staying in the business as a substantial portion of the profit margin is eradicated in these arrangements.

### SUMMARY OF THE INVENTION

It is an object of the present invention to provide a broadband system through which a consumer can select broadband service from any of a plurality of service providers.

It is another object of the present invention to provide such a system where the broadband service includes voice services and data services via a digital subscriber loop (DSL).

A first embodiment of the present invention is a communication network comprising (a) a multiplexer located in a building having a plurality of units, in which the multiplexer is coupled to the plurality of units via a local communication link, and (b) a switch coupled to the multiplexer via a synchronous optical network (SONET), for routing one or more communication packets between the multiplexer and a plurality of communication service providers. The plurality of units can transmit and receive the one or more communication packets to and from the plurality of communication service providers via the multiplexer.

A second embodiment of the present invention is a communication network comprising (a) a digital subscriber loop access multiplexer (DSLAM) and an integrated access device (IAD), coupled together and located in a building having a plurality of units, and in which the DSLAM is coupled to the plurality of units via a wiring harness, (b) a gateway coupled to a public service telephone network (PSTN) for converting a packetized voice over digital subscriber loop (DSL) signal to a standard telephone voice signal for the PSTN, and vice versa, and (c) an asynchronous transfer mode (ATM) switch coupled to the DSLAM via a synchronous optical network (SONET), for transmitting and receiving packetized voice over DSL signals to and from the gateway and for transmitting and receiving data packets to and from an Internet service provider. The plurality of units can transmit and receive the packetized voice over DSL signals and the data packets via the DSLAM.

A first method in accordance with the present invention provides for communication services by (a) locating a multiplexer in a building having a plurality of units, in which the multiplexer is coupled to the plurality of units via a local communication link, and (b) coupling a switch to the multiplexer via a synchronous optical network (SONET), for routing one or more communication packets between the multiplexer and a plurality of communication service providers. The plurality of units can transmit and receive the one or more communication packets to and from the plurality of communication service providers via the multiplexer.

A second method in accordance with the present invention provides for communication services by (a) locating a digital subscriber loop access multiplexer (DSLAM) and an integrated access device (IAD), coupled together, in a building having a plurality of units, in which the DSLAM is coupled to the plurality of units via a wiring harness, (b) coupling a gateway to a public service telephone network (PSTN) for converting a packetized voice over digital subscriber loop (DSL) signal to a standard telephone voice signal for the PSTN, and vice versa, and (c) coupling an asynchronous transfer mode (ATM) switch to the DSLAM via a synchronous optical network (SONET), for transmitting and receiving packetized voice over DSL signals to and from the gateway and for transmitting and receiving data packets to and from an Internet service provider. The plurality of units can transmit and receive the packetized voice over DSL signals and the data packets via the DSLAM.

### BRIEF DESCRIPTION OF THE DRAWINGS

FIG. 1 is a block diagram of a network configured in accordance with the present invention.

FIG. 2 is a block diagram of another embodiment of a network configured in accordance with the present invention.

FIG. 3 is a block diagram of yet another embodiment of a network configured in accordance with the present invention.

### DESCRIPTION OF THE INVENTION

The present invention relates to a communication network architecture that utilizes digital subscriber loop (DSL) technology for delivering services such as voice, data and video. DSL uses copper telephone lines to provide dedicated high-speed connections to data, video and voice networks. For a consumer, DSL can provide services such as video and music streaming and e-shopping. For a small business, it can provide high bandwidth, inter-office and intra-office communications.

DSL can be configured for symmetric and/or asymmetric connectivity at various bandwidth speeds. Symmetric DSL (SDSL) connectivity means the bandwidth of the connection is equal both directions, that is, a user can receive data at the same rate that the user can transmit data. The activities of sending and receiving large files are often best suited to SDSL. Asymmetric DSL (ADSL) connectivity means the bandwidth of the connection is such that the user is able to receive much more data than the user can send. ADSL is well suited, for example, for Internet surfing where a user typically downloads large quantity of data, e.g., images, but transmits only a small quantity of data to the network, e.g., a keyword for a search or an Internet address.

The present invention deploys DSL equipment in a multiple tenant unit (MTU) to enable tenants of the MTU to obtain services from any of a plurality of service providers. For example, one tenant can purchase long distance telephone, local telephone and Internet services from a first service provider, and another tenant can purchase high-speed Internet access from a second service provider and other telecommunication services from a third service provider. Thus, the present invention provides a broadband access system for an MTU, whereby a plurality of service providers can offer broadband services to the tenants of the MTU. The present invention also provides for a network that allows service providers to bypass the ILEC infrastructure.

The present invention is best described by reference to the associated figures. Throughout the following description, similar reference numerals refer to similar elements in all figures.

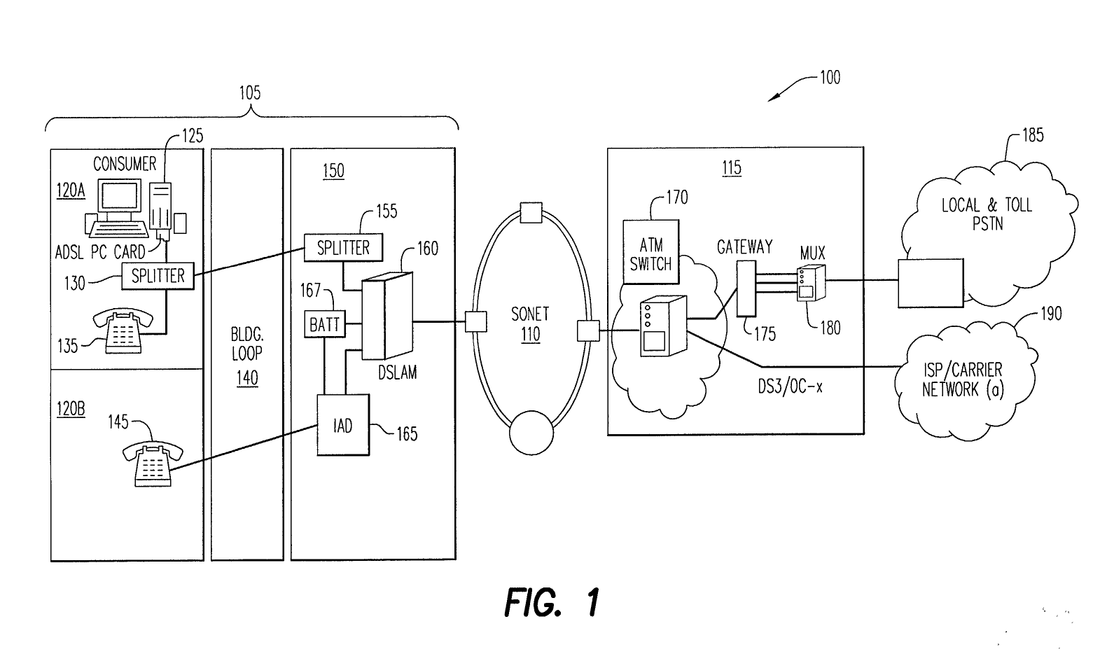

FIG. 1 is a block diagram of an exemplary network, generally indicated by reference numeral 100, configured in accordance with the present invention. The principal features of network 100 are an MTU 105, a point of presence (POP) 115, and a synchronous optical network (SONET) 110. MTU 105 and POP 115 are remotely located from one another. That is, they are not typically within a single building, and instead may be separated by several miles.

POP 115, which is typically located in a central office (CO) of a telephone company, provides a point of connection to an Internet service provider (ISP) 190 and a public switched telephone network (PSTN) 185. POP 115 includes an asynchronous transfer mode (ATM) switch 170, a gateway 175 and a multiplexer (MUX) 180. In the trade, a point of presence is sometimes known as a metropolitan point of presence (MPOP).

MUX 180 provides an interface between PSTN 185 and gateway 175. Although FIG. 1 shows only one PSTN 185 and only one ISP 190, the present invention is not limited as such, but instead, POP 115 is contemplated as interfacing with a plurality of PSTNs and ISPs. Accordingly, via MUX 180, gateway 175 can interface to more than one PSTN.

Gateway 175 interfaces with ATM switch 170 and converts a packetized voice over DSL signal from ATM switch 170 to a standard telephone voice signal for PSTN 185, and vice versa. A suitable component for use as gateway 175 is a GR 303 Gateway, available from Jetstream Communications.

ATM switch 170 transmits and receives ATM data packets between SONET 110 and either of gateway 175 and ISP 190. Generally, ATM is a switching technology that uses fixed-length packets to transmit data, voice and video over a local area network (LAN) or a wide area network (WAN). A Marconi TNX-1100 ATM switch is suitable for use as ATM switch 170.

SONET 110 provides a communication link between POP 115 and MTU 105. SONET 110 is preferably configured to support an optical transport level of at least DS3/OC-3.

MTU 105 is a building with a plurality of tenants. For example, MTU 105 may be a residential apartment building or a commercial office building having a plurality of member customer premises 120A, 120B. MTU 105 includes a service area 150, such as in a basement or other convenient area, in which are located several components of network 100. In the trade, a multiple tenant unit is sometimes known as a multiple dwelling unit (MDU).

Customer premises 120A, 120B include various data and/or communication equipment. For purpose of example, customer premises 120A is shown as having a splitter 130, a computer 125 and a telephone 135, and customer premises 120B is shown to have a telephone 145. Computer 125 is configured with an ADSL interface card.

Service area 150 houses a digital subscriber loop access multiplexer (DSLAM) 160, an integrated access device (IAD) 165, a splitter 155 and a backup power source, such as battery 167. The various data and/or communication equipment items in each of customer premises 120A and 120B are coupled to the components in service area 150 via a building wiring loop 140.

Wiring loop 140 is a harness through which customer premises 120A, 120B are accessed. Wiring loop 140 is thus a local communication link and it can be configured with traditional copper wires or with any appropriate medium, e.g., optical fiber, for routing of signals between service area 150 and customer premises 120A, 120B. DSLAM 160 is preferably situated in close proximity to a distribution point of wiring loop 140.

DSLAM 160 employs a combination of digital data modems and voice filtering technology, to deliver high speed data services to customers using the existing copper wire that provides conventional dial tone service. DSLAM 160, if configured to support voice and data services, uses ATM for QOS.

DSLAM 160 controls and routes DSL traffic and traditional voice service between customer premises 120A, 120B and SONET 110. It supports all aspects of DSL access, from basic IDSL, an ISDN-like service, for slower and distance sensitive applications, to full rate ADSL, e.g., 8 Mbps, for multimedia applications, and SDSL for symmetrical data and voice over DSL. Applications supported along this platform include standard high speed Internet access and a plurality of telephone lines, e.g., 16 lines, for voice. Streaming video or video on demand can also be delivered via DSLAM 160. One suitable example of DSLAM 160 is the Nokia D50 ATM/DSL Access Multiplexer, which is available from Nokia Corporation.

When DSLAM 160 receives an ATM packet from SONET 110 a permanent virtual circuit (PVC) upon which the packet traveled will route cells to either the IAD for voice or the corresponding DSL port on DSLAM 160. For data traffic the cell is transmitted through a low pass filter assembly (e.g., splitter 155), at which point the customer's existing voice traffic is merged with the data traffic and forwarded to the terminating DSL modem. Splitter 155 is a passive device that separates the high frequency DSL signal from the low frequency voice services. Voice traffic is delivered unimpeded to telephone locations by installing DSL splitters at each location. For voice calls, the traffic is first routed to the PVC that was configured for the IAD and normally uses SDSL technology.

An IAD is a device that supports voice, data and video streams over a single high capacity circuit. Specifically this equipment is located at the subscriber's location and communicates with the GR303 Voice Gateway at the POP AD. The IAD analyzes the inbound call and determines a port on the IAD to which the call should be sent. This is done by analyzing the call party digits within the cell stream. The IAD then converts the AAL2 cells into standard TDM POTS services.

IAD 165 delivers both voice service, i.e., voice packets, and data service, i.e., data packets, to customer premises 120B using a single pair of wires. IAD 165 simultaneously supports a plurality of standard voice circuits and a data circuit by dynamically allocating bandwidth to the voice circuits. For example, in one contemplated implementation, IAD 165 supports 16 standard voice circuits and a 512 Kbs data circuit. However, the present invention can include any practical number of voice and data circuits. IAD 165 can serve a plurality of customer premises. By centralizing IAD 165 in service area 150, rather than on or in customer premises 120A, 120B, the present invention can offer switched dial-tone services via voice over DSL technology to any customer premises that desires such services.

Backup battery 167 ensures that basic lifeline service is available to DSLAM 160 and IAD 165 in the event of a power outage. It also ensures telephone service support for at least telephone 145. In a preferred implementation, backup battery 167 provides operating power for at least 8 hours.

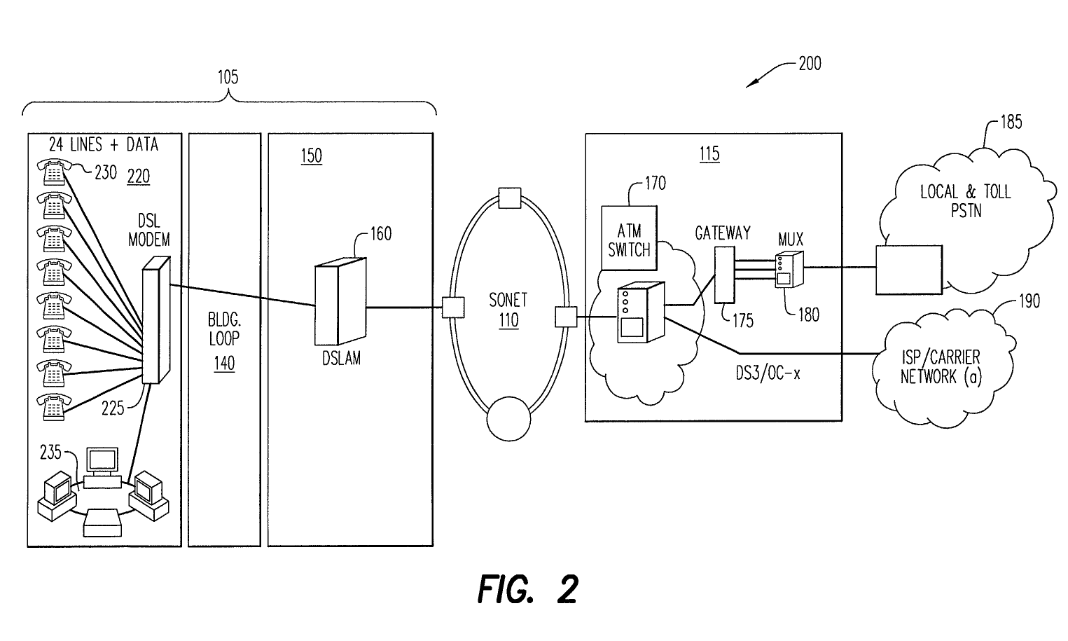

FIG. 2 is a block diagram of another embodiment of a network, generally indicated by reference numeral 200, configured in accordance with the present invention. Most of the components of network 200 are similar or identical to those of network 100, as shown in FIG. 1. However, in FIG. 2, MTU 105 is shown to include a customer premises 220 with a different configuration of data and/or communication equipment than that of either of customer premises 120A and 120B. More specifically, customer premises 220 includes an SDSL modem 225, a plurality of telephones 230 and a LAN 235. SDSL modem 225 is coupled to DSLAM 160 via wiring loop 140, and routes signals between DSLAM 160 and any of telephones 230 or LAN 235.

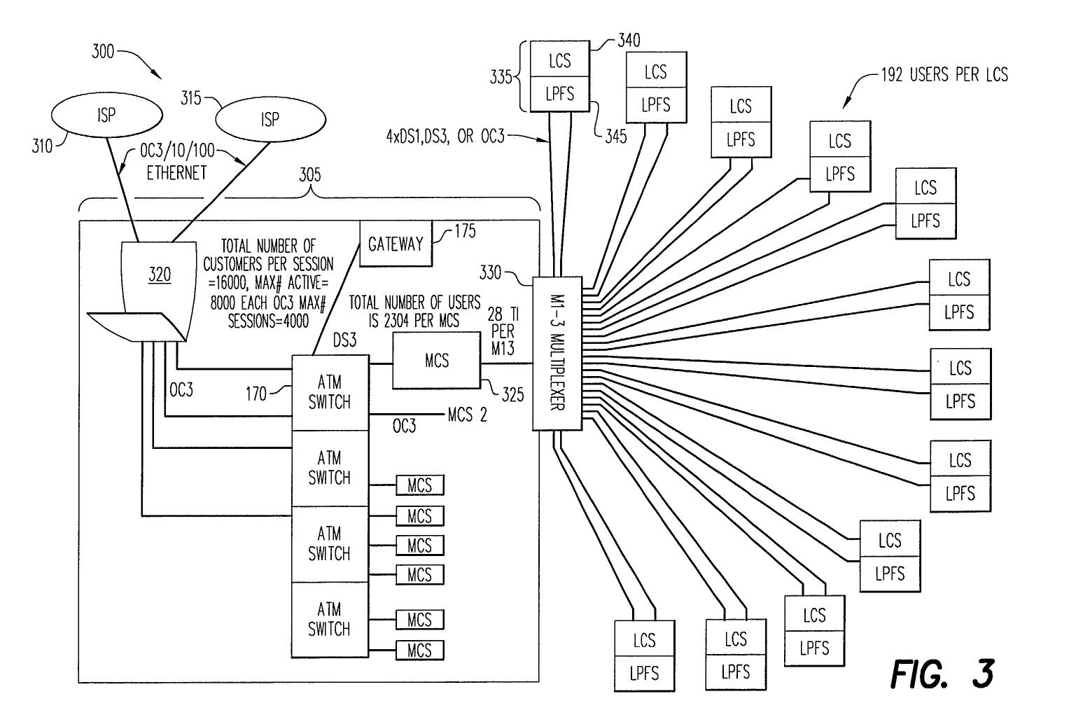

FIG. 3 is a block diagram of another embodiment of the present invention. A network 300 includes a POP 305 and a plurality of MTUs 335. POP 305 is located at a central site, remotely from the MTUs 335.

Each MTU 335 includes one or more of a line card shelf (LCS) 340 and a low pass filter shelf (LPFS) 345. LCS 340 is a portion of DSLAM 160 located at the MTU and houses all the DSL subscriber line cards. LPFS 345 is used in instances where by the data services and either new or existing voice services will be located on the same pair of copper wires.

Each LCS 340 is remotely connected to POP 305 via a digital carrier interface. A preferred interface between the MTUs 335 and POP 305 includes a plurality of TI carriers supporting at least 1.5 Mbps and a bandwidth of 6 Mbs via a Ti inverse multiplexed asynchronous (IMA) link. Additionally, DS3 and OC3 interfaces can be included. In one implementation of network 300, each LCS 340 has up to 192 ports, and thus, each LCS 340 supports up to 192 users.

G.lite is a form of ADSL, also known as universal ADSL, and available at data rates up to 1.5 Mbps over an existing phone line. Voice and data traffic are bundled onto a single pair of copper wires by an ADSL/G.lite card (not shown) within each LCS 340, and distributed over house riser cables and then terminated in each residence or business unit of the plurality of MTUs 335. Passband technologies, e.g., ADSL lines, connect to a low pass filter shelf and baseband technologies, e.g., SDSL, connect from a main distribution frame (MDF) (not shown) to an LCS backplane.

POP 305 includes a backbone router 320, a plurality of ATM switches 170, a gateway 175, a plurality of master control shelves (MCSs) 325, and a multiplexer 330.

Router 320 interfaces with each of an ISP 310 and an ISP 315 via an OC3 optical interface. Router 320 delivers AAL/5 IP packets to and from ISPs 310 and 315. A Redback SMS 1800, available from Redback Networks, is suitable for use as router 320.

Each ATM switch 170 interfaces, on one side, with router 320, and on the other side with one of the plurality of MCSs 325. Each ATM switch 170 drives ATM voice/data/and video packets across network 300 from MCS to either router 320 or gateway 175. Traffic from remote locations, separated into voice and data PVCs, is routed to a correct destination by an ATM switch 170. Data PVCs, e.g., AAL5, are forwarded to router 320 for transport to an ISP of choice, e.g., either of ISP 310 or 315, and voice PVCs are forwarded to gateway 175.

The voice PVC has different traffic parameters than the data PVC in order to ensure that an appropriate quality of service for telephony is applied. The dynamic bandwidth capabilities of gateway 175 are preferably supported with a variable bit real time (VBR-rt) virtual circuit. A single PVC provisioned for voice supports all of a customer's voice channels. When provisioning the PVC, the customer's line is associated with a logical port that is identified by an ATM virtual circuit and sub-channel number. The sub-channel number is mapped directly to a particular port on an IAD (see FIG. 1), and is defined as a call reference value (CVR). Each CVR is mapped to an appropriate interface group on gateway 175. Interface groups equate to physical port assignments on a Class 5 switch.

Gateway 175 is preferably capable of supporting up to 10 interface groups. Because of the ability to support a plurality of interface groups, network 300 can support a plurality of local service providers and allow customers who reside or work in MTUs 335 to obtain services from any of the plurality of local service providers.

Interfacing each MCS 325 into one of the ATM switches 170 is an optical link, for example, a 155 Mpbs OC-3 optical link. Each trunk takes both voice and data from each remote LCS 340 in the form of an AAL/2 voice and AAL/5 data layered service.

In one implementation of network 300, each MCS 325 supports up to 12 LCSs 340. Given 192 ports per LCS 340, as described above, network 300 can support up to 2,304 subscribers, i.e., 2,304=12×192.

It should be understood that various alternatives and modifications can be devised by those skilled in the art, and the present invention can be applied to other types of communications other than those that are conventionally regarded as broadband services. The present invention is intended to embrace all such alternatives, modifications and variances that fall within the scope of the appended claims.

What is claimed is:

1. A communication network comprising:
a multiplexer located in a building having a plurality of units, wherein said multiplexer is coupled to said plurality of units via a local communication link; and
a switch coupled to said multiplexer via a synchronous optical network (SONET), for routing one or more communication packets between said multiplexer and a plurality of communication service providers,
wherein said plurality of units can transmit and receive said one or more communication packets to and from said plurality of communication service providers via said multiplexer.

2. The communication network of claim 1, wherein said multiplexer comprises a digital subscriber loop access multiplexer (DSLAM).

3. The communication network of claim 1, wherein said switch comprises an asynchronous transfer mode (ATM) switch.

4. The communication network of claim 1,
wherein said plurality of communication service providers comprise a public switched telephone network (PSTN), and
wherein said communication network further comprises a gateway between said switch and said PSTN for converting between a packetized voice over digital subscriber loop (DSL) signal for said switch and a standard telephone voice signal for said PSTN.

5. The communication network of claim 1,
wherein said one or more communication packets comprises a voice packet and a data packet, and
wherein said communication network further comprises a device between said multiplexer and a member of said plurality of units, for transmitting and receiving said voice packet and said data packet to and from said member via said local communication link.

6. The communication network of claim 5, wherein said device supports a plurality of voice circuits and a data circuit for said member by dynamically allocating bandwidth to said plurality of voice circuits.

7. The communication network of claim 1, wherein said multiplexer interfaces with a symmetric digital subscriber loop modem for a member of said plurality of units.

8. The communication network of claim 1, further comprising a backup power source connected to said multiplexer for supplying power to said multiplexer.

9. A communication network comprising:
a digital subscriber loop access multiplexer (DSLAM) located in a building having a plurality of units, wherein said DSLAM is coupled to said plurality of units via a wiring harness;
a gateway coupled to a public service telephone network (PSTN) for converting between a packetized voice over digital subscriber loop (DSL) signal and a standard telephone voice signal for said PSTN; and
an asynchronous transfer mode (ATM) switch coupled to said DSLAM via a synchronous optical network (SONET), for transmitting and receiving packetized voice over DSL signals to and from said gateway and for transmitting and receiving data packets to and from an Internet service provider,
wherein said plurality of units can transmit and receive said packetized voice over DSL signals and said data packets via said DSLAM.

10. The communication network of claim 9, further comprising a device between said DSLAM and a member of said plurality of units, for transmitting and receiving said packetized voice over DSL signals and said data packets to and from said member via a pair of wires in said wiring harness.

11. The communication network of claim 9, further comprising a backup power source connected to said multiplexer for providing power to said multiplexer.

12. A method for providing communication services, comprising:
locating a multiplexer in a building having a plurality of units, wherein said multiplexer is coupled to said plurality of units via a local communication link; and
coupling a switch to said multiplexer via a synchronous optical network (SONET), for routing one or more communication packets between said multiplexer and a plurality of communication service providers,
wherein said plurality of units can transmit and receive said one or more communication packets to and from said plurality of communication service providers via said multiplexer.

13. The method of claim 12, wherein said multiplexer comprises a digital subscriber loop access multiplexer (DSLAM).

14. The method of claim 12, wherein said switch comprises an asynchronous transfer mode (ATM) switch.

15. The method of claim 12,
wherein said plurality of communication service providers comprise a public switched telephone network (PSTN), and
wherein said method further comprises positioning a gateway between said switch and said PSTN for converting between a packetized voice over digital subscriber loop (DSL) signal for said switch and a standard telephone voice signal for said PSTN.

16. The method of claim 12,
wherein said one or more communication packets comprises a voice packet and a data packet, and
wherein said method further comprises positioning a device between said multiplexer and a member of said plurality of units, for transmitting and receiving said voice packet and said data packet to and from said member via a pair of wires in said local communication link.

17. The method of claim 16, wherein said device supports a plurality of voice circuits and a data circuit for said member by dynamically allocating bandwidth to said plurality of voice circuits.

18. The method of claim 12, wherein said multiplexer interfaces with a symmetric digital subscriber loop modem for a member of said plurality of units.

19. The method of claim 12, further comprising connecting a backup power source to said multiplexer for supplying power to said multiplexer.

20. A method for providing communication services, comprising:
locating a digital subscriber loop access multiplexer (DSLAM) in a building having a plurality of units, wherein said DSLAM is coupled to said plurality of units via a wiring harness;
coupling a gateway to a public service telephone network (PSTN) for converting between a packetized voice over digital subscriber loop (DSL) signal and a standard telephone voice signal for said PSTN; and
coupling an asynchronous transfer mode (ATM) switch to said DSLAM via a synchronous optical network (SONET), for transmitting and receiving packetized voice over DSL signals to and from said gateway and for transmitting and receiving data packets to and from an Internet service provider,
wherein said plurality of units can transmit and receive said packetized voice over DSL signals and said data packets via said DSLAM.

21. The method of claim 20, further comprising positioning a device between said DSLAM and a member of said plurality of units, for transmitting and receiving said packetized voice over DSL signals and said data packets to and from said member via said wiring harness.

22. The method of claim 20, further comprising connecting a backup power source to said DSLAM for providing power to said DSLAM.
